(19) United States
(12) Patent Application Publication
(10) Pub. No.: US 2025/0230516 A1
(43) Pub. Date: Jul. 17, 2025

(54) Method and Device for Producing Hardened Sheet-Steel Components

(71) Applicant: voestalpine Metal Forming GmbH, Krems an der Donau (AT)

(72) Inventors: Tobias HÄGELE, Schwäbisch Gmünd (DE); Andreas Sommer, Seelach 2 (DE); Florian Gerstner, Aalen (DE)

(73) Assignee: voestalpine Metal Forming GmbH, Krems an der Donau (AT)

(21) Appl. No.: 18/848,504

(22) PCT Filed: Mar. 24, 2023
(86) PCT No.: PCT/EP2023/057674

§ 371 Date: Sep. 18, 2024

(30) Foreign Application Priority Data
Mar. 25, 2022 (DE) 10 2022 107 131.6

(51) Int. Cl. C21D 9/00; C21D 1/18; C21D 9/46; C22C 38/02; C22C 38/06; C22C 38/44; C22C 38/46; C22C 38/50; C22C 38/54; C22C 38/58

(52) U.S. Cl. CPC C21D 9/0025; C21D 1/18; C21D 9/0056; C21D 9/46; C22C 38/02; C22C 38/06; C22C 38/44; C22C 38/46; C22C 38/50; C22C 38/54; C22C 38/58

(57) ABSTRACT

The invention relates to a method for heating a sheet steel blank or preformed component with a zinc or zinc alloy coating, wherein the sheet steel component or blank is guided or positioned in a furnace and heated to a temperature above the austenitizing temperature, the sheet steel component or blank at least temporarily rests on a plurality of support surfaces on at least one carrier in which, on the support surfaces for the sheet steel blank or component, either
a) the support surfaces are each a maximum of 200 mm² in size, and/or
b) the support surfaces consist of a porous and/or rough oxide ceramic or carbide ceramic or high-temperature resistant cast steel so that oxygen access to the surface of the steel sheet blank or component is ensured even in the region of the support surface

An apparatus for carrying out the method is also provided.

### RELATED APPLICATIONS

This patent application is a 35 U.S.C. § 371 National Stage entry of PCT/EP2023/057674, filed Mar. 24, 2023, which in turn claims priority based on German Patent Application DE 10 2022 107 131.6, filed Mar. 25, 2022, the disclosures of which are incorporated herein by reference.

### FIELD OF THE INVENTION

The invention relates to a method and an apparatus for producing hardened steel components.

### BACKGROUND OF THE INVENTION

Hardened steel components have the advantage, particularly in body construction for motor vehicles, that their outstanding mechanical properties make it possible to produce a particularly stable passenger cell without having to use components which, at normal strengths, would be much more massive and thus heavier.

Hardened steel components of this kind are produced using steel grades that can be hardened by means of a quench hardening. Steel grades of this kind include, for example, boron-alloyed manganese carbon steels, wherein the most commonly used in this case is 22MnB5. But other boron-alloyed manganese carbon steels are also used for this purpose.

To produce the hardened components from these steel grades, it is necessary to heat the steel material to the austenitizing temperature (>Ac3) and wait until the steel material is austenitized. Depending on the desired degree of hardness, partial or full austenitization can be achieved here.

If after the austenitization, a steel material of this kind is cooled at a speed above the critical hardening speed, then the austenitic structure transforms into a martensitic, very hard structure. This makes it possible to achieve tensile strengths Rm of up to over 1500 MPa.

There are currently two common methods for producing steel components.

In so-called form hardening, known from EP1651789B1, a sheet steel blank is cut from a steel strip, for example by cutting or punching, and then formed into the finished component in a conventional, for example four-step, deep-drawing, trimming, and postforming process. In this case, this finished component is slightly smaller in size in order to compensate for a subsequent thermal expansion during the austenitization.

The component produced in this way is then austenitized in at least some regions and then inserted into a form hardening tool in which it is pressed but not formed or formed only very slightly. The pressing causes the heat to be dissipated from the component into the form hardening tool, specifically at a speed higher than the critical hardening speed.

The second common method is so-called press hardening, also known as direct process. In press hardening, a sheet steel component is produced by heating a flat sheet blank made of a hardenable steel to a temperature above the austenitizing temperature so that at least in some regions, the structure of the steel is in the form of the high temperature modification, namely austenite. This flat sheet blank is then formed into a desired shape in a forming tool, usually with a single forming stroke, and heat is extracted from the steel material through the contact with the forming tool halves at such a speed that a martensitic hardening occurs, in which the austenite is substantially transformed into martensite. In order for this to occur, the speed of heat removal must be above the so-called critical hardening speed, which is usually above 20 Kelvin per second.

In both methods, sheet blanks coated with metallic anti-corrosion layers, in particular containing zinc or a zinc-based alloy, can be used.

Form hardening is also referred to as the indirect process (e.g. phs-ultraform) and press hardening is also referred to as the direct process (e.g. phs-directform). In the direct process, metallic aluminum-silicon anti-corrosion layers with an aluminum content of at least 80 wt % are also commonly used. Since the aluminum-silicon layer is very brittle at room temperature, the coating can flake off during the cold forming, which is why this coating variant is not usually used for the indirect process.

The advantage of the indirect process is that because of the preceding multi-step cold forming, it is possible to achieve more complex component geometries and to eliminate a trimming in the hardened state. The advantage of the direct process is that only one tool, namely the press hardening tool, is required, but the achievable component complexity is lower and a trimming to final contour in the hardened state is required.

Thus during the form hardening, fully formed and usually also fully trimmed and perforated components are guided through a furnace or placed into a furnace and heated to the austenitizing temperature. For transport or placement, these components are placed on furnace carriers; these furnace carriers usually must provide sufficient support points to prevent creeping and/or sagging and/or twisting and/or tilting during their holding time in the furnace and, to ensure an accurately positioned removal after the heating and subsequent accurately positioned insertion into the form hardening tool, can also have stops and/or receiving pins, for example, which engage in corresponding holes in the components. Advantageously, the furnace carriers have a component-specific contour matching the component geometry in order to support the component in its entire geometry to prevent creeping and/or sagging and/or twisting and/or tilting. In the case of simpler components that are not at risk of tilting, the components can also be placed on universal transport elements or universal placement rails in the furnace and positioned during or after the removal from the furnace and before the insertion into the form hardening tool.

In press hardening, flat sheet blanks must be transported through the furnace and heated, or placed in the furnace and then heated; for this reason, press hardening in principle requires significantly more support points, i.e. support surfaces, than form hardening since for lack of stiffening, the flat sheet blank can otherwise bend considerably during the heating, making it difficult to transport the blank through the furnace in an accurately positioned way, remove it from the furnace in an accurately positioned way, and then insert it into the press hardening tool in an accurately positioned way. In press hardening, the sheet blank is thus in principle supported by significantly more support points than the component is in in form hardening, which means that for a comparable size of sheet blank and component, the number of support points is greater in press hardening, but the dead-weight load per support point is greater in form hardening.

The furnace for both press hardening and form hardening can be embodied either as a continuous furnace, for example a lifting step conveyor furnace or walking beam furnace or chain conveyor furnace or roller hearth furnace, or as a chamber furnace, for example, as a multi-chamber furnace or so-called “pizza oven”.

For the austenitization, therefore, the material being heated is always in contact with a transporting, holding, or heating device. In the case of galvanized sheets, these contact surfaces or points always constitute an influence on the surface; due to vibrations and/or layer reactions (e.g. exothermic reactions) during the holding time in the furnace, the influence on the surface by a contact surface can be greater than the influence exerted by the contact surface all by itself. In the case of galvanized material, there is a risk of the layer being abraded or damaged and in addition, a risk of so-called efflorescence up to and including local burn-off occurring on the layer. Aluminum-silicon layers, which cannot be used in the indirect method but can be used in the direct method, are subject to different technological requirements, for example no efflorescence or local burn-off are known to occur on the contact surfaces with these coatings, but they also do not permit any cathodic corrosion protection.

This can affect the surface of galvanized material; for example, it can have a negative impact on the corrosion protection and/or paint adhesion of the components and/or also have an undesirable visual appearance.

### SUMMARY OF THE INVENTION

The object of the invention is to provide a method for producing hardened steel components in which efflorescence and damage to the galvanized surface on the support surfaces during the heating in a furnace are reduced or eliminated.

The object is attained with a method having the features described and claimed herein.

Advantageous further embodiments are described and claimed herein.

Another object is to provide an apparatus for carrying out the method with which the transport and/or the support of sheet blanks or components in the furnace takes place more gently.

The object is attained with an apparatus having the features described and claimed herein.

Advantageous further embodiments are described and claimed herein.

It is known that a coating of zinc or a zinc-based alloy on a steel sheet substrate forms a very thin aluminum oxide layer on the surface when heated for austenitizing purposes, provided that a small amount of aluminum is contained in the zinc coating. This oxide layer protects the underlying zinc, which melts upon further heating.

Without this aluminum oxide layer, the zinc coating oxidizes to the point of burning or partially vaporizes. As the holding time in the furnace increases, the liquid zinc underneath the protective aluminum oxide skin transforms into zinc ferrite at the boundary layer to the iron and above that, transforms into a zinc-iron alloy, usually with rather heterogeneously distributed concentrations.

According to the invention, a sheet steel blank or a steel strip is used that is embodied with a zinc coating or zinc alloy coating. This zinc coating or zinc alloy coating can have a layer thickness of 5 μm to 20 μm per side. This advantageously enables a good corrosion protection. In particular, the coating can be a Z120 or Z140 or Z180 according to DIN EN 10346.

Zinc coatings can have a comparatively high zinc content of 85 wt % to 98 wt % and, in addition to inevitable impurities, still contain aluminum in the range of 0.2 to 2 wt %. Other elements with an affinity for oxygen, such as magnesium, can also be present.

Particularly preferably, the zinc coating or zinc alloy coating can be applied by means of the hot-dip method. This can constitute a simple and robust application method.

According to the invention, it has been discovered that, particularly in the press hardening process and thus the transport of a sheet heated in this way through the furnace, a support surface must be present, which makes it possible to promote the self-healing effect of the material, or more precisely the surface, in the event of damage to the protective aluminum oxide layer. According to the invention, this is achieved by the fact that if sufficient oxygen is present and the damage is slight, the aluminum oxide skin forms again and thus continues to protect the liquid zinc.

According to the invention, the contact surface between a supporting or transport medium and the steel blank resting on it must be embodied in such a way that sufficient oxygen reaches the support surface. In addition, the contact surface does not cause damage to the aluminum oxide layer in the event of vibration during furnace transport or furnace residence; in order to avoid the coating adhering to or being deposited on it, the contact surface or more precisely, the material composing the contact surface, on the transporting or supporting medium is as inert as possible or has as little affinity as possible with respect to the zinc coating of the steel blank resting on it.

These contact surfaces are advantageously cleanable, wherein the contact surfaces are geometrically advantageously embodied in such a way that there is no elongated linear support or excessively sharp point support that could damage the surface. Small approximately round, approximately square, or approximately rectangular contact surfaces that are 7 to 200 mm² in size have turned out to be advantageous according to the invention. Preferably, in the case of approximately rectangular contact surfaces, the length-to-width ratio can be between 1:1 and 5:1.

For example, yttrium-stabilized zirconium dioxide is a particularly preferred material. This material is temperature-resistant, very hard, and permits diffusion of oxygen ions at temperatures above 600° C. Another suitable material is aluminum oxide, which on the one hand has a low affinity relative to the support materials of the steel material and on the other hand is also resistant to high temperatures. Another suitable material is a chromium-nickel steel with a high silicon content on which a closed oxide layer forms at high temperatures and which has little affinity relative to the zinc coating.

But other ceramic materials with a sufficiently high degree of roughness and/or porosity can also serve as oxygen storage materials, for example silicon carbide (SiC) or other carbide ceramics. In this case, it is advantageous if the ceramic material has an open porosity of 20 to 60 vol %, in particular 25 to 35 vol %, and/or a roughness of Rz>30 μm, in particular Rz>100 μm.

It is also conceivable to use honeycombs, which have an advantageous ratio between oxygen and contact surface, as well as open-pored materials such as metallic or ceramic sponge or foam structures, high-temperature resistant fabric materials, and the like.

Surprisingly, it has turned out that for purposes of the invention, what is advantageous is not a very smooth polished surface, which would be expected to reduce adhesion, but rather a rough surface. The invention will be explained below by way of example with reference to the drawings.

Alternatively, the inventors have discovered that to begin with, a sharp reduction in the size of the support surfaces of the furnace carriers, particularly in form hardening, i.e. the indirect process with preformed components, can be sufficient to avoid surface damage such as zinc efflorescence. For this purpose, instead of the usual support surface of about 400 mm² in size (i.e. about Ø23 mm or a square edge length of 20 mm), this is reduced to a maximum of 200 mm² (i.e. a maximum of about Ø 16 mm or a square edge length of 14 mm). Support surfaces that are each 7 mm² to 200 mm² in size, particularly preferably 13 mm² to 113 mm² (i.e. about Ø 3 mm to Ø 16 mm or a square edge length of 3 mm to 14 mm, particularly preferably Ø 4 mm to Ø 12 mm or a square edge length of 4 mm to 11 mm), have proven particularly suitable.

The lower limit of 7 mm² or an edge length of 3 mm should not be undershot since this can lead to increased wear or even destruction of the support surface due to the constant temperature treatment and heating and cooling steps in conjunction with vibrations. The upper limit of 200 mm² for each support surface should not be exceeded in order to prevent in a particularly reliable way corresponding efflorescence or other surface damage that can lead to poor corrosion protection, among other things.

Advantageously, this means that the steel material previously used for the furnace carriers can still be used, which is a cost advantage.

In addition, the dimensional stability of the parts should be ensured or more precisely stated, the components can be better protected against twisting or other undesirable changes in shape.

The invention therefore relates in particular to a method for heating a sheet steel blank or a preformed sheet steel component with a zinc coating or zinc alloy coating, wherein the sheet steel component or sheet steel blank is guided through a furnace or is placed or positioned in a furnace and is heated in the furnace in particular to a temperature above the austenitizing temperature, wherein the sheet steel component or sheet steel blank rests at least temporarily on a plurality of support surfaces on at least one carrier, wherein a carrier is used in which, on the support surfaces for a sheet steel blank or a sheet steel component, either
a) the support surfaces are each a maximum of 200 mm² in size, preferably a maximum of 113 mm², and/or
b) the support surfaces consist of a porous and/or rough oxide ceramic or carbide ceramic or high-temperature resistant cast steel so that oxygen access to the surface of the steel sheet or steel component is ensured even in the region of the support surface.

According to one embodiment, the carrier is coated with, covered with, or made of an oxide ceramic, a carbide ceramic, or a high-temperature resistant steel.

According to one embodiment, the support surfaces on the carrier are each set to be at least 7 mm² in size, preferably 13 mm².

According to one embodiment, the oxide ceramic or carbide ceramic or high-temperature resistant cast steel has an open porosity of 20 to 60 vol % and/or a roughness of Rz>30 μm, in particular Rz>100 μm.

According to one embodiment, a carrier is used, which has a plurality of adjacent support surfaces, wherein the support surfaces are made of the oxide ceramic and wherein the support surfaces are spaced apart from one another.

According to one embodiment, yttrium-stabilized zirconium oxide and/or aluminum oxide is used as the material for the contact surface between the carrier and the sheet blank and/or the component.

According to one embodiment, honeycomb bodies, in particular ceramic honeycomb bodies and/or ceramic fibers and/or ceramic fabric and/or open-pored materials such as metallic or ceramic sponge or foam structures are used as the carriers and/or support surfaces.

According to one embodiment, the sheet steel component or sheet steel blank is made of a hardenable steel alloy, in particular a boron-manganese steel.

According to one embodiment, the sheet steel component or sheet steel blank with the following composition is used (all figures in wt %):

| | | |
|---|---|---|
| Carbon | up to 0.4, | preferably 0.15 to 0.3 |
| Silicon | up to 1.9, | preferably 0.11 to 1.5 |
| Manganese | up to 3.0, | preferably 0.8 to 2.5 |
| Chromium | up to 1.5, | preferably 0.1 to 0.9 |
| Molybdenum | up to 0.9, | preferably 0.1 to 0.5 |
| Nickel | up to 0.9, | |
| Titanium | up to 0.2 | preferably 0.02 to 0.1 |
| Vanadium | up to 0.2 | |
| Tungsten | up to 0.2, | |
| Aluminum | up to 0.2, | preferably 0.02 to 0.07 |
| Boron | up to 0.01, | preferably 0.0005 to 0.005 |
| Sulfur | max. 0.01, | preferably max. 0.008 |
| Phosphorus | max. 0.025, | preferably max. 0.01 |

Residual iron and impurities.

According to one embodiment, the sheet steel blank is heated for austenitizing purposes and then formed or is first cold formed into a sheet steel component and then heated for austenitizing purposes, and after the austenitization, the sheet steel blank or formed sheet steel component is cooled at a speed above the critical cooling speed.

According to one embodiment, the zinc coating or zinc alloy coating has a layer thickness of 5 μm to 20 μm per side, in particular 7 μm to 15 μm per side. This can further increase the corrosion protection, in particular cathodic corrosion protection.

Another aspect of the invention relates to an apparatus for heating sheet steel blanks and/or sheet steel components with a zinc coating or zinc alloy coating, wherein the apparatus has at least one carrier with a plurality of support surfaces for at least temporarily supporting a sheet steel blank or a sheet steel component, wherein the carrier has support surfaces for a sheet steel blank or component on the side facing the blank or component, in which
a) the support surfaces are each a maximum of 200 mm² in size, preferably a maximum of 113 mm², and/or
b) the support surfaces are made of a porous and/or rough oxide ceramic or carbide ceramic or high-temperature resistant cast steel.

According to one embodiment, the carrier has a succession of adjacent truncated pyramids, truncated cones, columns, or punches, wherein the support surfaces for the sheet blank or workpiece are formed by the surfaces of the truncated cones, truncated pyramids, columns, or punches facing the workpiece or blank.

According to one embodiment, the support surfaces of the ceramic have a square, polygonal, or round surface with a size of up to 200 mm² each.

According to one embodiment, the support surfaces on the carrier each have a support surface area of 7 mm² to 200 mm², in particular 13 mm² to 113 mm².

According to one embodiment, the truncated pyramids and/or truncated cones and/or columns and/or punches are positioned on a support made of high-temperature resistant steel, silicon carbide, oxide ceramics or other heat-resistant supports.

According to one embodiment, the truncated cones, truncated pyramids, columns, or punches are embodied as plasma sprayed and have a rough surface that is produced by the plasma spraying.

According to one embodiment, the supports are embodied of a ceramic material such as yttrium-stabilized zirconium dioxide or aluminum oxide.

According to one embodiment, the oxide ceramic or carbide ceramic or high-temperature resistant cast steel has an open porosity of 20 to 60 vol % and/or a roughness of Rz>30 μm, in particular Rz>100 μm.

### BRIEF DESCRIPTION OF THE DRAWINGS

The invention will be explained below by way of example with the aid of the drawings. In the drawings:

FIG. 1 schematically depicts the indirect process (form hardening, phs-ultraform, i.e. without trimming in the hardened state);

FIG. 2 shows the difference between furnace carriers (contour-following) and furnace placement rails (non-contour-following) in the example of a chamber furnace;

FIG. 3 shows an example of the effect of creeping or sagging after the furnace in the case of insufficient support in a continuous furnace;

FIG. 4 shows an example of the effect of creeping or sagging after the furnace in the case of insufficient support in a chamber furnace;

FIG. 5 shows an example of a component surface at contact points in the prior art;

FIG. 6 shows an example of a component surface at contact points with implementation according to the invention;

FIG. 7 shows an example of the reduced support surface according to the invention;

FIG. 8 shows an example of the support or support surface according to the prior art;

FIG. 9 shows an example of the reduced support surface according to the invention;

FIG. 10 shows a furnace support according to the invention for the indirect phs (ultraforming) process;

FIG. 11 shows four different variants of a furnace placement surface;

FIG. 12 shows a plasma-sprayed, yttrium-stabilized zirconium dioxide placement surface with an unmachined surface;

FIG. 13 shows a detailed enlargement of the placement surface according to FIG. 12;

FIG. 14 shows a placement surface according to FIG. 13 made of aluminum oxide;

FIG. 15 shows a placement surface made of heat-resistant cast steel;

FIG. 16 a) shows a placement honeycomb made of solid ceramic;

FIG. 16 b) shows a placement honeycomb made of ceramic fibers;

FIG. 16 c) shows the surface contour of a honeycomb body made of solid ceramic;

FIG. 16 d) shows the surface contour of a ceramic fabric;

FIG. 16 e) shows a ceramic foam structure;

FIG. 17 is a depiction of a honeycomb body from FIG. 16 a) and three sheet metal parts resting on it that have been heated (according to the invention);

FIG. 18 is a depiction of a ceramic fiber plate from FIG. 16 d) and three sheet metal parts resting on it that have been heated (according to the invention).

### DETAILED DESCRIPTION OF THE INVENTION

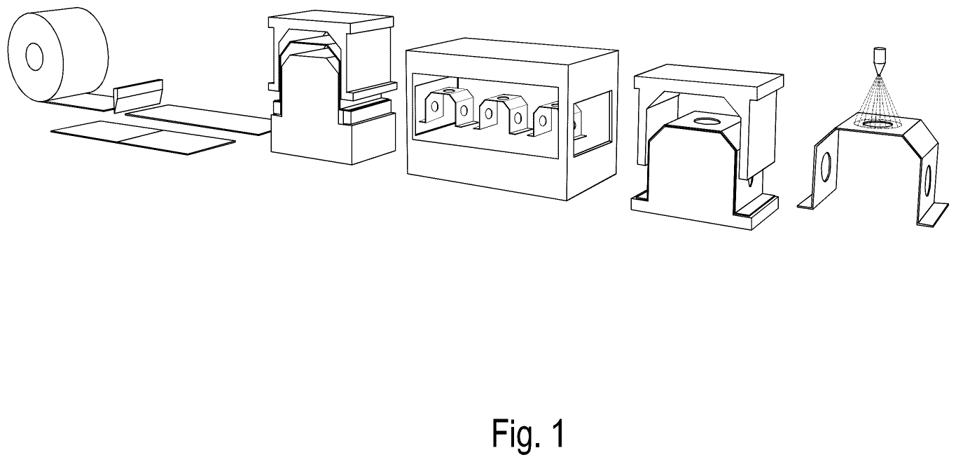

The indirect process is schematically depicted in FIG. 1, where it is clear that the component geometry including trimming on the outer contour and production of the hole pattern have already been completed after the cold forming, i.e. before the furnace heating, and the trimming on the outer contour and production of the hole pattern are no longer carried out in the hardened state, i.e. after quench hardening in the form hardening tool. This means that after the heating of the furnace, the components must be inserted into the form hardening tool in the correct position; otherwise, uncorrectable dimensional deviations of the outer contour and hole pattern will occur as well as undesirable deformations in the form hardening tool. For this reason, in the example of the continuous furnace shown, an exact positioning of the component is necessary particularly during furnace unloading, in order to be able to advantageously enable an exact positioning in the form hardening tool on the processing side, for example by means of robots. This can also be used analogously for the direct process (not shown) with undeformed or slightly preformed sheet blanks.

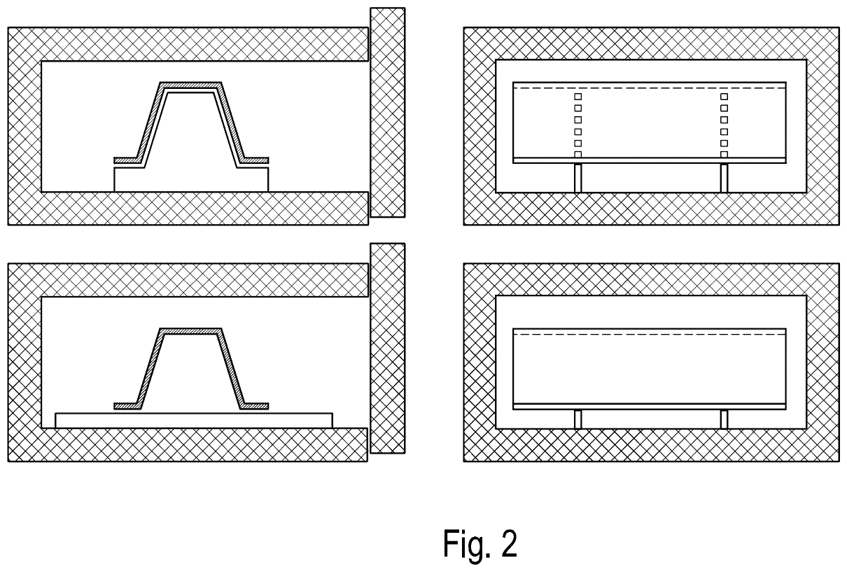

FIG. 2 shows an example of the difference between a component placement on furnace carriers that follow the contours of the component and a component placement on (non-contour-following, possibly also universal) furnace placement rails using the example of a chamber furnace. The side view is shown on the left, with the right block, which is not connected to the rest, symbolizing the furnace door, and the respective front view is shown on the right. The upper figures show a contour-following component placement and the lower ones show a component placement on rails.

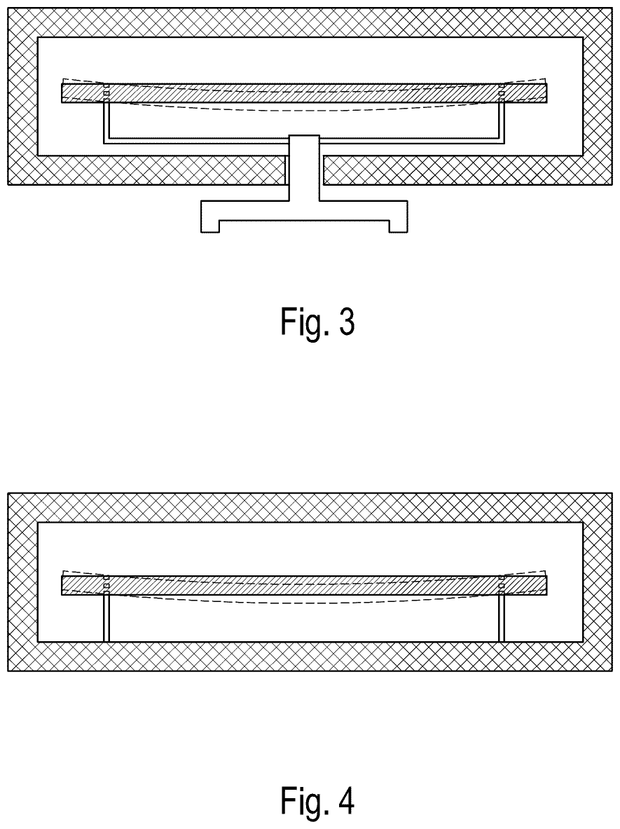

During the heat treatment in the furnace, creeping or sagging of the steel material can occur; this is illustrated in FIG. 3 in the example of a continuous furnace and in FIG. 4 in the example of a chamber furnace. In order to counteract the creeping or sagging and possibly also a twisting and/or tilting, sufficient support of the steel material must be ensured.

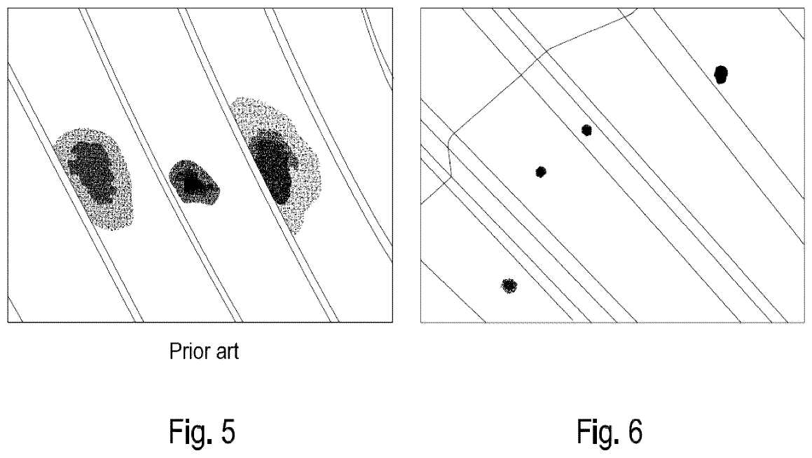

A very large support surface on coated steel material, however, can lead to efflorescence or other surface degradation, as shown in FIG. 5.

With a support surface reduction according to the invention, though, such a surface degradation at the contact points or support surfaces either does not form or only does so to a comparatively minor extent, as shown in FIG. 6.

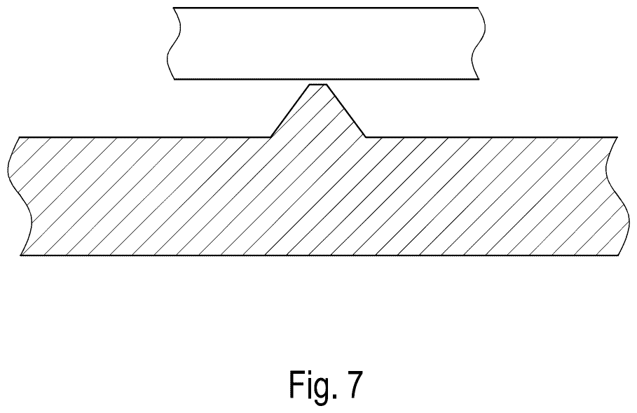

According to the invention, for the carrier or support, a carrier is used that has a contour on the side facing the workpiece or sheet blank. According to the invention, this can be a placement rail, support rail, furnace support, component support, or the like. FIG. 7 shows an example of such a contour (the cross-hatched region is the carrier). In this case, this carrier has a plurality of support surfaces, preferably at least three, in order to ensure a geometrically stable state.

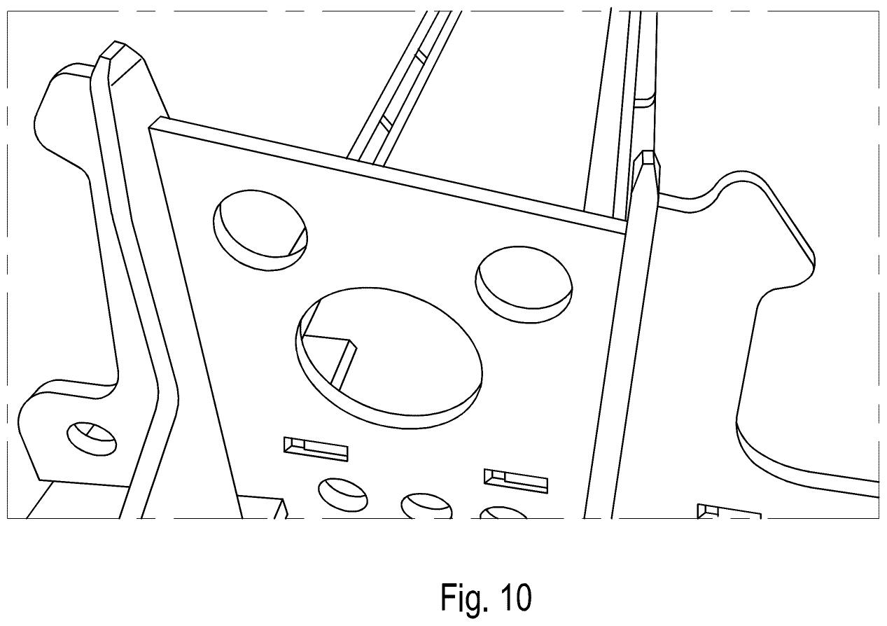

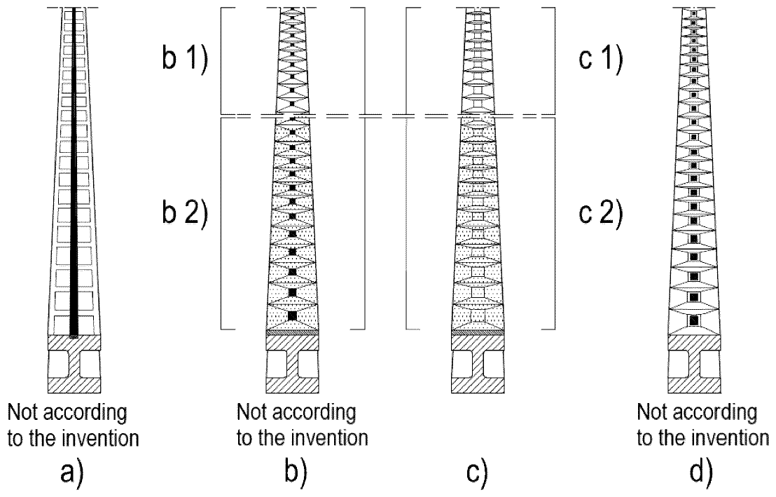

A cross-section through an entire carrier, i.e. an example of a furnace carrier for a component for use in the indirect process is shown in FIG. 9 (the cross-hatched region is the component) and a three-dimensional depiction of it is shown in FIG. 10.

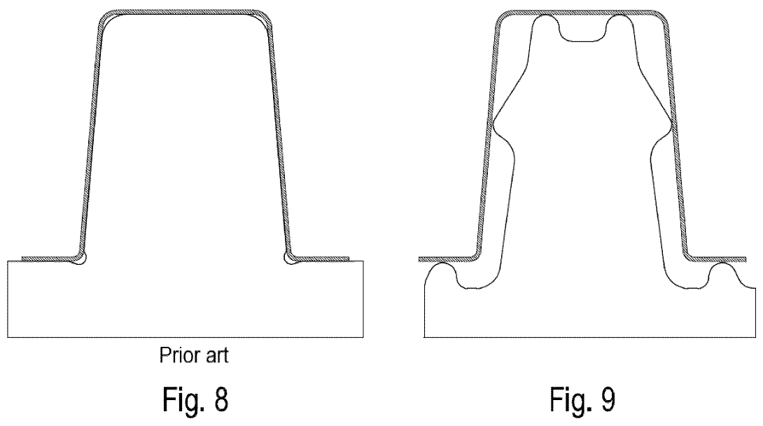

A linear contact or linear support surfaces, by contrast, are known from the prior art (FIG. 8).

The contour of a support, however, can also be a sequence of truncated pyramids that are adjacent to one another, for example, with the actual support surfaces being the top surfaces of the truncated pyramids while the base surfaces of the truncated pyramids contact one another. FIG. 11 c) shows an example of such a rail-shaped furnace support surface with truncated pyramids positioned on it.

The four variants shown in FIG. 11 are a ceramic rod in FIG. 11 a); truncated pyramids coated with aluminum oxide (Al2O3) in the polished state in the upper region of FIG. 11 b); truncated pyramids coated with zirconium oxide (ZrO) in the polished state in the lower region of FIG. 11 b); truncated pyramids coated with aluminum oxide in the rough state in the upper region of FIG. 11 c); truncated pyramids coated with zirconium oxide in the rough state in the lower region of FIG. 11 c), and truncated pyramids coated with sol-gel in FIG. 11 d).

It has surprisingly turned out that the ceramics, especially Al2O3 and ZrO in the rough state, caused much less surface degradation than those same ceramics when polished.

The top surfaces of the truncated pyramids have an approximately square surface, for example, with an edge length of roughly 4 to 12 mm, which corresponds to a support surface of 13 mm² to 113 mm² in size.

In this case, the truncated pyramids can be positioned, for example, on a support made of heat-resistant steel, silicon carbide, or similar heat-resistant supports, or the entire support can be made of these.

Preferably, the top surfaces of the truncated pyramids in this case are plasma sprayed, for example, and consist of a ceramic, in particular oxide ceramic, material.

A certain surface roughness is produced by means of the plasma spraying or the like or by means of methods that are used especially for this purpose.

Zirconium dioxide and aluminum oxide are particularly suitable oxide ceramic materials. Carbide ceramic materials can also be used.

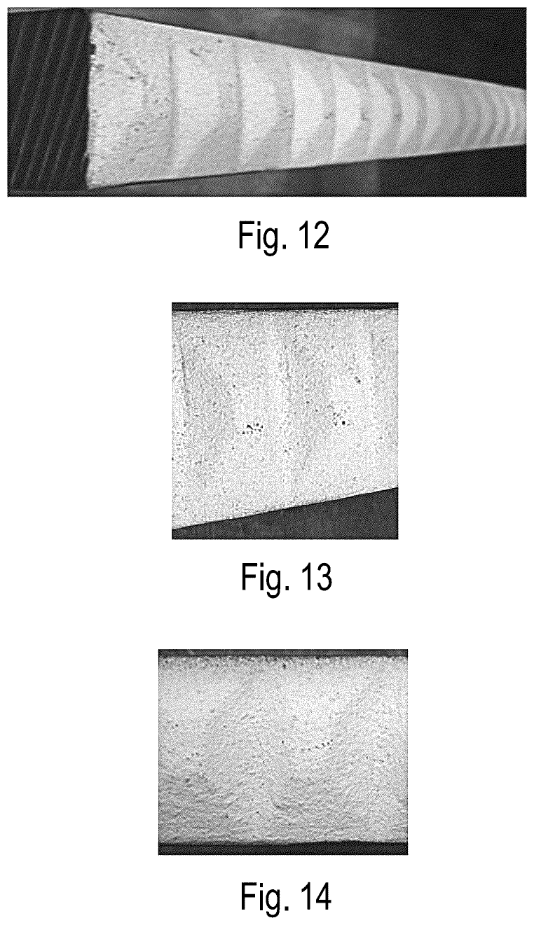

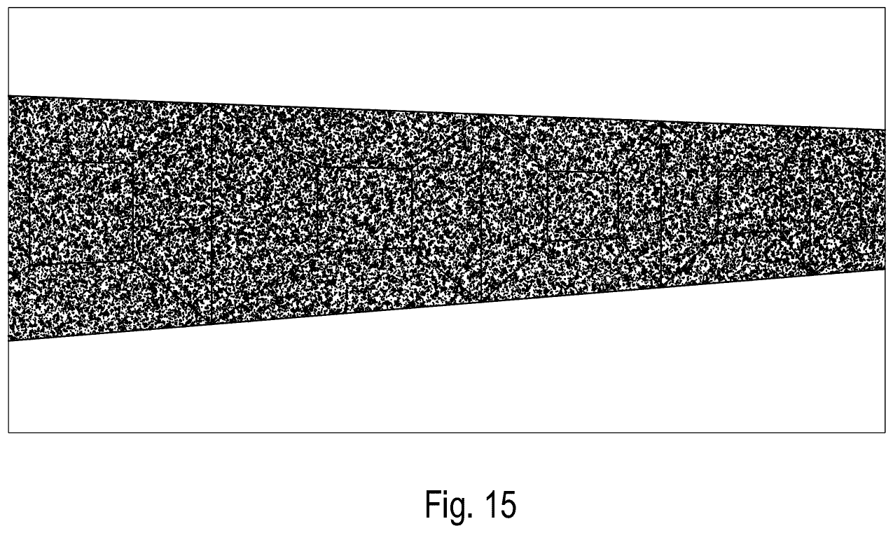

Instead of the truncated pyramids shown in FIGS. 12 to 14, it is of course also conceivable to use other geometric shapes such as truncated cones or columns.

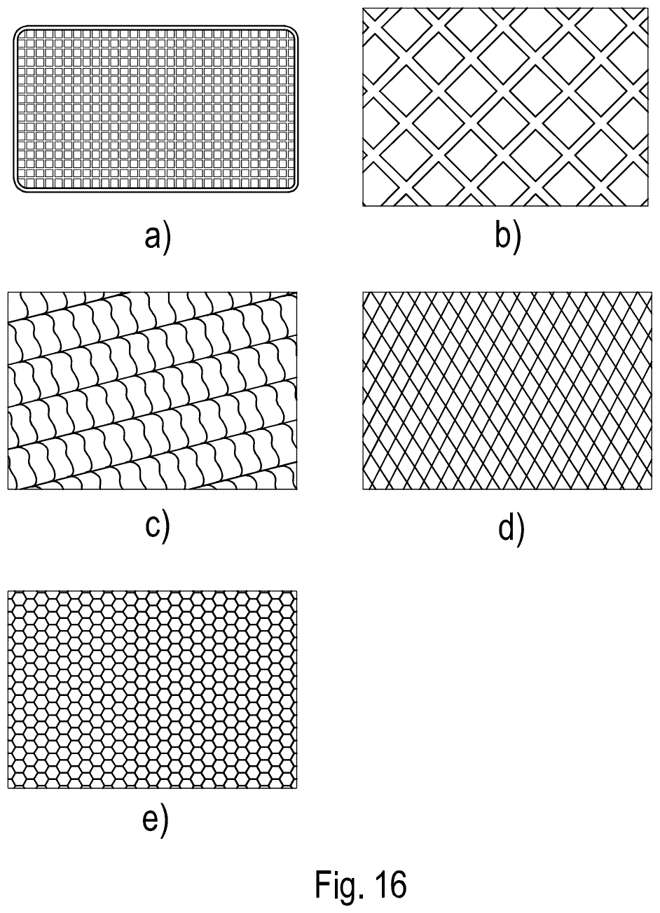

In another advantageous embodiment, the support surfaces are embodied as honeycomb bodies made of solid ceramic (FIG. 16 a). In this case, the honeycomb bodies can only be positioned individually and spaced apart on a support; the individual honeycomb bodies can have edge lengths of 5 to 25 mm, for example. The honeycomb bodies in this case are preferably embodied of a solid ceramic material such as yttrium-stabilized zirconium dioxide or aluminum oxide. This can have a roughness of Rz=23 μm, for example.

In another advantageous embodiment, the load-bearing surface of the carrier is formed entirely as a honeycomb body, which in this case is embodied as correspondingly elongated.

The honeycombs can have a cross-section that is square, but also polygonal, in particular hexagonal.

In another advantageous embodiment, the honeycomb body is made of ceramic fibers (FIG. 16 b), wherein this ceramic fiber honeycomb body can be positioned over an entire carrier or likewise can be positioned only partially or selectively on a carrier.

It can be particularly advantageous for the surface contour to be not flat and in particular not polished, but rather to have a roughness or microcontour. Such a surface contour can be embodied by the fact that no further finishing of the surface is carried out after the flame or plasma spraying or, in the case of a honeycomb body, no finishing of the surface is carried out either, resulting in a surface contour such as the one shown in FIG. 16 c).

Usable ceramic fabrics usually also have surfaces with an existing contour or roughness, as shown in FIG. 16 d).

Foams or microfoams that also have a microstructure formed by the pores on their surfaces are also suitable (FIG. 16 e).

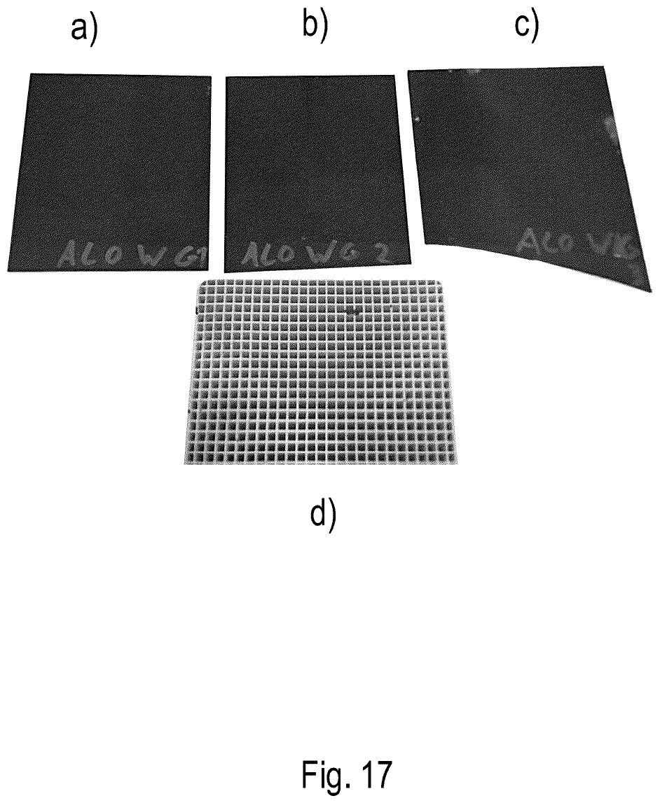

For this purpose, a honeycomb body shown in FIG. 16 a) was used to heat treat three overlying galvanized sheet metal parts, and these did not exhibit any surface degradation (see FIG. 17).

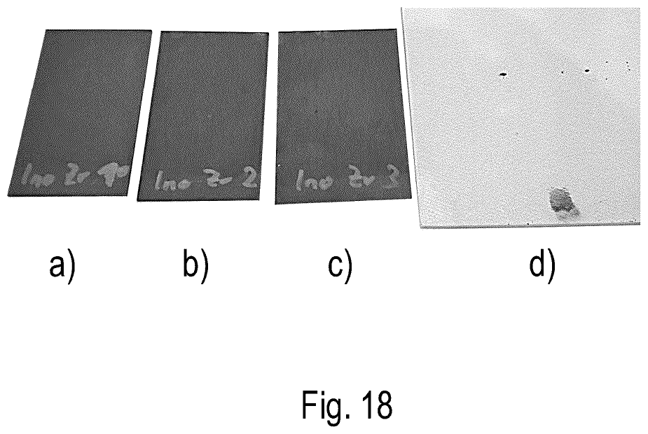

Three steel sheet parts were also laid on a ceramic fiber plate according to FIG. 16 d); in this example, a high-temperature composite of silica fabric with a predominantly Al2O2 matrix was selected as the ceramic fiber plate and this also resulted in no surface degradation of the galvanized steel sheet parts (shown in FIG. 18). For example, this has a roughness of Rz=57 μm.

The invention will be explained below by means of experiments.

### Experiment 1

A sheet metal blank that is embodied with an aluminum-silicon coating is placed on coated placement elements.

In this case, the placement elements consist of firstly a ceramic rod lying in a longitudinal direction, secondly truncated pyramids made of aluminum oxide in which the contact surfaces are polished, truncated pyramids embodied in the same way as the ones mentioned above, but made of yttrium-stabilized zirconium oxide,

truncated pyramids made of plasma-sprayed aluminum oxide without surface treatment, truncated pyramids made of yttrium-stabilized zirconium oxide embodied in the same manner, and a carrier with truncated pyramids coated with a sol-gel method.

A test furnace is heated to a temperature, which, in terms of heat transfer, is high enough to heat the sheet blank to about 930° C.

After the sheet blank has been removed and cooled, the sheet blank exhibits clear changes to the metallic surface in the region of the ceramic rod, which are not OK on visual inspection.

The parts of the sheet blank that rested on the truncated pyramids made of polished aluminum oxide and polished zirconium oxide are of borderline quality from a visual standpoint and are also not in a state that can be considered acceptable.

The sheet blank in the region of the sol-gel supports also does not appear to be OK.

Only in the region of the aluminum oxide placement elements and the zirconium oxide placement elements, which are unpolished, is the sheet blank OK in terms of surface quality.

### Experiment 2

A sheet blank made of a zinc-coated sheet is conveyed in a furnace.

The sheet blank exhibits surface deterioration consisting of zinc efflorescence, among other things, which is an unacceptable surface degradation.

### Experiment 3

A sheet blank of the kind in experiment 2 is used, with the supports once again corresponding to the supports used in experiment 1.

In the region of the ceramic rod support, the sheet blank shows such severe surface changes that a ceramic rod support with a narrow linear support surface cannot be used.

Surface changes that are unacceptable are also observed in the region of the sol-gel coated support.

In the case of the aluminum oxide support, which was polished, and the zirconium support, which was polished, surface changes are also observed, but these are clearly less pronounced than those of the ceramic rod or the sol-gel coating.

No negative changes can be detected in the case of an aluminum oxide coating and a zirconium oxide coating or silicon carbide coating, which have a roughness and/or porosity. For example, the silicon carbide coating can have a roughness of Rz=49 μm.

### Experiment 4

This experiment is the same as experiment 3, but the sheet blank is raised and lowered during the heating.

In the region of the ceramic rod support and the sol-gel support, powerful negative changes of the surface are exhibited. Changes are also observed in the region of the polished aluminum oxide support and the unpolished aluminum oxide support.

The zirconium oxide supports exhibit little or no changes, with the zirconium oxide support without surface grinding achieving the best result.

Overall, it can also be stated in this connection that zirconium oxide and aluminum oxide in the unpolished state are the best supports.

### Experiment 5

A preformed alloy-galvanized component is guided through a continuous furnace with a furnace carrier and is austenitized.

The support surfaces each have a surface area of between 210 mm² and 400 mm².

After the hardening and cooling of the component from the form hardening tool, the hardened component exhibits significant changes in the metallic surface in the region of the support surfaces that are not OK on visual inspection. In particular, zinc efflorescence, which is shown in FIG. 5, cannot be accepted and therefore the part constitutes a reject.

### Experiment 6

The same as experiment 5, but the support surfaces were reduced even further and each have a surface area of 13 mm² to 100 mm².

Surprisingly, it has turned out that after the hardening and cooling of the component, after the removal from the form hardening tool, the surface damage in this case was greatly reduced and, despite the lack of adjustment to the material of the furnace carrier, minor efflorescence was visually discernible here, but this did not constitute material damage to the component. This material was therefore considered OK.

According to the invention, it has been discovered that in high-temperature processes for austenitizing sheet steel blanks or sheet steel components with a zinc coating or zinc alloy coating, the carrier must be selected in such a way that the existing zinc coating or zinc alloy coating of the sheet steel blanks or sheet steel components is not damaged or is able to perform its self-healing functions in the event of damage.

According to the invention, it has been discovered that ceramic coatings on the carriers or ceramic carriers are suitable for this purpose if they do not have smooth polished surfaces but instead have rough and/or porous surfaces. It has been shown that ceramic coatings made of oxide ceramics or carbide ceramics and in particular made of aluminum oxide and zirconium oxide, in particular yttrium-stabilized zirconium oxide, but also rough cast steel achieve the desired effect.

According to the invention, it has been discovered that, as an alternative or in addition to ceramic coatings, a comparatively sharp reduction in the size of the support surfaces of furnace carriers to less than 200 mm² also resulted in the existing zinc coating or zinc alloy coating not being damaged or being able to perform its self-healing functions in the event of damage.

Within the scope of the invention, it is also possible to provide a carrier with some support surfaces below the above-mentioned size of 200 mm² and additionally some support surfaces that are porous and/or rough, i.e. a mixture of the two variants.

1-19. (canceled)

20. A method for heating a sheet steel blank or a preformed sheet steel component having a zinc coating or zinc alloy coating, comprising the steps of:
guiding the sheet steel blank or component through a furnace or placing the sheet steel blank or component in the furnace; and
heating the sheet steel blank or component in the furnace to a temperature above an austenitizing temperature of the sheet steel blank or component;
wherein the sheet steel blank or component rests at least temporarily on a plurality of support surfaces on at least one carrier, and either:
a) the support surfaces each have a maximum area of 200 mm², and/or
b) the support surfaces include at least one of an oxide ceramic, a carbide ceramic, and a high-temperature resistant cast steel so that oxygen access to the steel sheet or steel component is ensured even a region of each support surface.

21. The method according to claim 20, wherein the carrier is coated with, covered with, or made of the oxide ceramic, carbide ceramic, or high-temperature resistant cast steel.

22. The method according to claim 20, wherein the support surfaces each have an area of at least 7 mm².

23. The method according to claim 21, wherein the oxide ceramic, carbide ceramic, or high-temperature resistant cast steel has an open porosity of 20 to 60 vol % and/or a roughness of Rz>30 μm.

24. The method according to claim 20, wherein the carrier has a plurality of adjacent support surfaces, the support surfaces are made of the oxide ceramic, and the support surfaces are spaced apart from one another.

25. The method according to claim 20, wherein the support surfaces comprise a contact material formed of yttrium-stabilized zirconium oxide and/or aluminum oxide.

26. The method according to claim 20, wherein the at least one carrier and/or the support surfaces comprise ceramic honeycomb bodies, ceramic fibers, ceramic fabric, and/or open-pored metallic or ceramic sponge or foam structures.

27. The method according to claim 20, wherein the sheet steel component or sheet steel blank comprises a boron-manganese steel.

28. The method according to claim 20, wherein the sheet steel component or sheet steel blank has the following composition, in percent by weight:

| | |
|---|---|
| Carbon | up to 0.4, |
| Silicon | up to 1.9, |
| Manganese | up to 3.0, |
| Chromium | up to 1.5, |
| Molybdenum | up to 0.9, |
| Nickel | up to 0.9, |
| Titanium | up to 0.2 |
| Vanadium | up to 0.2 |
| Tungsten | up to 0.2, |
| Aluminum | up to 0.2, |
| Boron | up to 0.01, |
| Sulfur | max. 0.01, |
| Phosphorus | max. 0.025, |

Residual iron and impurities.

29. The method according to claim 28, wherein the sheet steel component or sheet steel blank has the following composition, in percent by weight:

| | |
|---|---|
| Carbon | 0.15 to 0.3, |
| Silicon | 0.11 to 1.5, |
| Manganese | 0.8 to 2.5, |
| Chromium | 0.1 to 0.9, |
| Molybdenum | 0.1 to 0.5, |
| Nickel | up to 0.9, |
| Titanium | 0.02 to 0.1, |
| Vanadium | up to 0.2, |
| Tungsten | up to 0.2, |
| Aluminum | 0.02 to 0.07, |
| Boron | 0.0005 to 0.005, |
| Sulfur | max. 0.008, |
| Phosphorus | max. 0.01, |

Residual iron and impurities.

30. The method according to claim 20, further comprising at least one of the following steps:
forming the sheet steel blank after heating to the austenization temperature;
cold forming the sheet steel blank before heating to the austenization temperature; and
after heating to the austenization temperature, cooling the steel sheet blank or component at a speed above a critical cooling speed.

31. The method according to claim 20, wherein the zinc coating or zinc alloy coating has a layer thickness of 5 μm to 20 μm.

32. An apparatus for heating sheet steel blanks and/or sheet steel components having a zinc coating or zinc alloy coating, comprising:
at least one carrier having a plurality of support surfaces for at least temporarily supporting the sheet steel blank or sheet steel component; and
support surfaces on the carrier for contacting the sheet steel blank or component, in which:
a) the support surfaces each have a maximum area of 200 mm² and/or
b) the support surfaces include at least one of an oxide ceramic, a carbide ceramic, and a high-temperature resistant cast steel.

33. The apparatus according to claim 32, wherein:
the carrier comprises a succession of adjacent truncated pyramids, truncated cones, columns, or punches; and
the support surfaces are formed by surfaces of the truncated pyramids, truncated cones, columns, or punches.

34. The apparatus according to claim 32, wherein the support surfaces have a square, polygonal, or round surface with an area up to 200 mm² each.

35. The apparatus according to claim 32, wherein the support surfaces each have an area of 7 mm² to 113 mm².

36. The apparatus according to claim 33, wherein the truncated pyramids, truncated cones, columns, or punches are positioned on the carrier, and the carrier is made of the oxide ceramic, carbide ceramic, or high-temperature resistant cast steel.

37. The apparatus according to claim 33, wherein the truncated cones, truncated pyramids, columns, or punches are formed by plasma spraying and have rough surfaces produced by the plasma spraying.

38. The apparatus according to claim 32, wherein the support surfaces comprise a contact material formed of yttrium-stabilized zirconium oxide and/or aluminum oxide.

39. The apparatus according to claim 32, wherein the oxide ceramic, carbide ceramic, or high-temperature resistant cast steel has an open porosity of 20 to 60 vol % and/or a roughness of Rz>30 μm.

40. A method for heating a sheet steel blank or a preformed sheet steel component having a zinc coating or zinc alloy coating, comprising the steps of:
guiding the sheet steel blank or component through a furnace or placing the sheet steel blank or component in the furnace; and
heating the sheet steel blank or component in the furnace to a temperature above an austenitizing temperature of the sheet steel blank or component;
wherein the sheet steel blank or component rests at least temporarily on a plurality of support surfaces on at least one carrier, and either:
a) the support surfaces each have an area of 13 mm² to 113 mm², and
b) the support surfaces include at least one of an oxide ceramic, a carbide ceramic, and a high-temperature resistant cast steel so that oxygen access to the steel sheet or steel component is ensured even a region of each support surface.
